(19) United States
(12) Patent Application Publication
(10) Pub. No.: US 2012/0315359 A1
(43) Pub. Date: Dec. 13, 2012

(54) READY-TO-EAT CEREAL FLAKES CONTAINING LEGUMES

(76) Inventors: Kalpesh Gandhi, Battle Creek, MI (US); Roger S. Wenk, Battle Creek, MI (US)

(21) Appl. No.: 13/488,715

(22) Filed: Jun. 5, 2012

Related U.S. Application Data
(60) Provisional application No. 61/495,482, filed on Jun. 10, 2011.

(51) Int. Cl. A23L 1/164; A23P 1/02; A23L 1/20; A23P 1/08

(52) U.S. Cl. 426/93; 426/621; 426/454; 426/634

(57) ABSTRACT

Ready-to-eat cereal flakes include 10 to 50 weight percent (wt %) legumes, such as black beans, and have a can weight of 19 to 22 ounces per 231 cubic inches and structural integrity similar to conventional ready-to-eat cereal flakes. The cereal flakes also include 6 to 13 wt % protein isolate, processing aid in an amount of 3 to 9 wt % and 18 to 66 wt % grains. The cereal flakes provide at least 7 grams of protein and at least 6 grams of fiber per 52 gram serving. In one process, the cereal flakes are formed by cooking and extruding a combined mass of the legumes, protein isolate, processing aid and grains without expansion of the combined mass. The extruded mass is processed in a cold pellet former and cut into a plurality of non-expanded pellets which are dried to a moisture content of 14 to 24 wt %. The pellets are then flaked at a temperature of 110 to 150° F. and dried to a final moisture of 1 to 5 wt %.

### RELATED APPLICATIONS

This application claims the benefit of U.S. provisional application Ser. No. 61/495,482 filed Jun. 10, 2011.

### TECHNICAL FIELD

The present invention relates to ready-to-eat food products containing legumes, and more particularly to flaked ready-to-eat breakfast cereals containing legumes.

### BACKGROUND OF THE INVENTION

Legumes, also known as pulses, have excellent nutritional qualities, including significant amounts of protein and dietary fiber, with very low amounts of fat, calories, sugar, and cholesterol. For example, a half cup serving of black beans provides 7 grams of protein and 6 grams of dietary fiber, with only 1 gram of fat, 140 calories, 0 grams of sugar, and 0 grams of cholesterol. Consumers wanting to reduce their blood pressure and improve their overall health are encouraged to replace red meat and other animal-based sources of protein in their diet with legumes and legume-based sources of protein. The major legumes include beans, peas, lentils, and peanuts. Legumes contain vitamins and antioxidants that may prevent various diseases, such as heart disease and cancer.

Due to the exceptional nutritional and health benefits, consumers want more legumes in their diet. Thus, a variety of ready-to-eat food products including legumes and legume-based sources of protein have been developed. U.S. Pat. No. 7,235,276 to Allen et al. discloses a puffed food dough including soy protein isolate or legume protein isolate; grains, such as wheat and rice; and a total protein content of 50 to 75%. The Allen patent teaches the puffed food dough could be used to form ready-to-eat foods, such as ready-to-eat cereal.

U.S. Patent Application Publication No. 2007/0087107 to Borders et al. discloses food products containing legumes from sources, such as beans, peas, and lentils, preferably navy beans and pinto beans, and in a variety of forms, such as legume powder or flour. The legumes comprise from 10 to 100% by weight of the food product. Borders teaches the food product can take a variety of forms, such as an extrusion puffed cereal piece or cereal crisp product.

However, food products of the prior art including a significant amount of legumes are difficult to form into ready-to-eat cereal flakes. This is because legumes do not functionally contribute to physical properties, such as elasticity and cohesiveness, as do the grains of conventional ready-to-eat cereals. The prior art does not disclose an example or otherwise teach one of skill in the art of how to form ready-to-eat cereal flakes including a significant amount of legumes which also have a structural integrity, texture, size, shape, and overall appearance similar to conventional ready-to-eat cereal flakes.

### SUMMARY OF THE INVENTION

The invention provides ready-to-eat cereal flakes including grains, protein isolate and legumes having a desirable taste and a structural integrity similar to conventional ready-to-eat cereal flakes, and methods of producing the same.

One aspect of the invention includes a food product comprising a plurality of flakes. The flakes have a can weight of 19 to 22 ounces and a moisture content of 1 to 5%, based on the total weight of the flakes. The flakes include grain in an amount of 18 to 66 weight percent (wt %), legumes in an amount of 10 to 50 wt %, at least one processing aid in an amount of 3 to 9 wt %, and at least one protein isolate in an amount of from 6 to 13 wt %, all based on the total weight of the flakes.

Another aspect of the invention provides a method of forming a flaked ready to eat cereal comprising the steps of: forming a food mass by combining in an extruder grain in an amount of from 18 to 66 weight percent, legumes in an amount of 10 to 50 weight percent, protein isolate in an amount of 6 to 13 weight percent, and processing aid in an amount of 3 to 9 weight percent, all based on the total weight of the food mass, and cooking the food mass in the extruder; extruding the cooked food mass from the extruder in a non-expanded form and introducing the non-expanded extrudate into a cold-former pellet former and forming the food mass into non-expanded pellets at a temperature of 100° F. or less, the non-expanded pellets having a moisture content of from 24 to 33 weight percent and a density of from 30 to 40 grams per 100 pellets; drying the pellets to a moisture content of from 14 to 24 weight percent; flaking the pellets at a temperature of from 110 to 150° F.; and drying and toasting the flakes to a final moisture content of from 1 to 5 weight percent.

In another method, forming a flaked ready-to-eat cereal comprises the steps of: forming a food mass by combining in a cooker grain and protein isolate and cooking the food mass in the cooker at a pressure of 20 to 25 pounds per square inch; adding to the food mass water and processing aid and cooking at 20 to 25 psi until a moisture content of the food mass is from 30 to 36 weight percent; removing the cooked food mass from the cooker and then cooling the cooked food mass and drying it to a moisture content of from 24 to 33 weight percent; milling the cooked food mass through a screen having openings of from ⅛ to ⅝ of an inch in diameter and then further drying the milled food mass to a moisture content of from 20 to 26 weight percent; combining the milled food mass with legumes and further water in a cold pellet former and cold forming non-expanded pellets; drying the pellets to a moisture content of from 14 to 21 weight percent and then flaking them at a temperature of from 110 to 150° F.; and drying and toasting the flakes to a final moisture content of from 1 to 5 weight percent.

In another method forming a flaked ready-to-eat cereal comprises the steps of: cooking grain in an amount of from 18 to 66 weight percent, protein isolate in an amount of 6 to 13 weight percent, legumes in an amount of from 10 to 50 weight percent and processing aid in an amount of from 3 to 9 weight percent based on the total weight of the flakes at 20 to 25 psi to a moisture content of from 30 to 36 weight percent; removing the cooked mass from the cooker and cooling and drying to a moisture content of from 26 to 32 weight percent; adding the dried food mass to a rotary pellet former and cold forming non-expanded pellets; drying the pellets to a moisture content of from 14 to 21 weight percent and then flaking them at a temperature of from 110 to 150° F.; and drying and toasting the flakes to a final moisture content of from 1 to 5 weight percent.

The ready-to-eat cereal flakes provide the nutritional and health benefits typically associated with legumes, such as significant amounts of protein and fiber, with low amounts of fat, calories, and cholesterol. The cereal flakes can provide at least 7 grams of protein and at least 6 grams of fiber per 52 gram serving. Unlike some ready-to-eat food products containing legumes, the ready-to-eat cereal flakes have a desirable taste, rather than a bitter or overwhelming bean-like taste. The cereal flakes also have a structural integrity, processability, texture, size, shape, and overall appearance similar to conventional grain-based ready-to-eat cereal flakes. The structural integrity is an unexpected result given the significant amount of legumes in the cereal flakes because legumes do not functionally contribute to physical properties, such as elasticity and cohesiveness, as do the grains that are typically used to prepare conventional ready-to-eat cereal flakes.

### BRIEF DESCRIPTION OF THE DRAWINGS

FIG. 1 is a flow chart of a method of forming the ready-to-eat cereal flakes according to a preferred embodiment of the invention; and

FIG. 2 is a flow chart of a method of forming the ready-to-eat cereal flakes according to an alternative embodiment of the invention.

### DETAILED DESCRIPTION OF THE INVENTION

The invention provides ready-to-eat cereal flakes including legumes and methods of producing the same. The cereal flakes also include protein isolate, grains, flavor additives, and gum acacia. The cereal flakes can include other ingredients typically used in ready-to-eat breakfast cereals, such as supplements and preservatives. The cereal flakes provide at least 7 grams of protein and at least 6 grams of fiber, but typically 9 grams of protein and 8 grams of fiber, per 52 gram serving.

The finished ready-to-eat cereal flakes have a structural integrity, texture, size, shape, and overall appearance similar to conventional ready-to-eat cereal flakes. The finished cereal flakes typically have a moisture content of 1 to 5 wt %, preferably 2 to 4 wt % based on the total flake weight. The finished cereal flakes also preferably have a “can weight” of 19 to 22 ounces. The can weight is the weight of the cereal flakes filling a 231 cubic inch volume. The can weight is measured by filling a container or can having a volume of 231 cubic inches with the cereal flakes, and then measuring the total weight of the cereal flakes in the container. The flakes are not compressed prior to weighing.

The ready-to-eat cereal flakes of the invention also have a bowl life similar to conventional ready-to-eat cereal flakes. The ready-to-eat cereal flakes maintain a desirable crunchiness for over two minutes when disposed in a bowl of milk.

The terms “legume” or “legumes” refer to the seeds of grain legumes and products derived from them, such as flours, grits, particulates, powders, and other seed-based products. Unless otherwise stated, the amount of each ingredient of the cereal flakes is the amount before any cooking or processing of the ingredients. Unless otherwise stated, the amount of each ingredient in the flakes is provided in weight percent (wt %), which means the weight of the ingredient relative to the total weight of all the ingredients of the cereal flakes.

### Legumes

The cereal flakes include at least one legume with the total legumes in an amount of at least 10 wt %, preferably 10 to 50 wt %, and more preferably 15 to 22 wt %, based on the total weight of the cereal flakes. The legumes are preferably cracked black beans or black bean grits, but can include any type of legume, pea, lentil, chickpea, bean, or any combination thereof, except vanilla beans and coffee beans. The legumes can be whole or in the form of grits, powder, flour, or particulates. In one embodiment, the legumes are black beans provided as precooked, dehydrated particulates. In another embodiment, the legumes are black bean grits. The whole legumes, legume grits, or legume particulates may be discernable in the finished ready-to-eat cereal flakes, whereas the legume powders and flours are typically not discernable.

### Protein Isolate

The cereal flakes also include at least one protein isolate with the total protein isolates in an amount of at least 6 wt %, preferably 6 to 13 wt %, and more preferably 8 to 11 wt %, based on the total weight of the cereal flakes. The protein isolate is preferably pea protein isolate, but can include soy protein isolate, gluten protein isolate, milk protein isolate, or any combination thereof. The pea protein isolate is a natural, healthy, and environmentally friendly product. The pea protein isolate is made using water extraction, rather than a traditional hexane extraction process having harmful environmental effects. The pea protein isolate includes high levels of essential amino acids, such as cysteine, methionine, histidine, isoleucine, leucine, valine, lysine, phenylalanine, tyrosine, threonine, and tryptophan.

### Grains

The cereal flakes also include at least one grain with the total amount of grain present in an amount of 18 to 66 wt %, preferably 35 to 66 wt %, more preferably 42 to 63 wt %, and even more preferably 45 to 57 wt %, based on the total weight of the cereal flakes. The grains are preferably a blend of whole grains, rice, brown rice, and wheat, but can include oats, barley, corn, millet, buckwheat, sorghum, triticale, or any combination thereof. The grains can be provided in a variety of forms, such as whole, flour, powder, meal, grits, flakes, bran, and germ. In one embodiment, the cereal flakes include a combination of whole grains, broken whole grain brown rice, and cracked hard red winter wheat.

The cereal flakes typically include the whole grains in an amount of at least 2 wt %, preferably 2 to 8 wt %, and more preferably 4 to 6 wt %, based on the total weight of the cereal flakes. In one embodiment, the whole grains of the cereal flakes include a whole grain blend comprising whole oat groats, whole long grain brown rice, whole hard red winter wheat, whole rye, whole triticale, whole hulled barley, and buckwheat groats.

The cereal flakes typically include the rice in an amount of at least 10 wt %, preferably 10 to 25 wt %, and more preferably 18 to 23 wt %, based on the total weight of the cereal flakes. In one embodiment, the rice is broken whole medium grain brown rice.

The cereal flakes also typically include the wheat in an amount of at least 22 wt %, preferably 22 to 34 wt %, and more preferably 26 to 30 wt %. In one embodiment, the wheat is cracked hard red winter wheat. In another embodiment, the cereal flakes include wheat flour and wheat bran.

### Processing Aids

The cereal flakes include at least one processing aid for improving processability. The processing aids are typically present in an amount of at least 3 wt %, preferably 3 to 9 wt %, and more preferably 5 to 7 wt %, based on the total weight of the cereal flakes. In one preferred embodiment, the cereal flakes include gum acacia as a processing aid. The gum acacia is present in an amount of at least 3 wt %, preferably 3 to 9 wt %, and more preferably 5 to 7 wt %. The gum acacia is used to prevent the cereal flakes from breaking apart during processing and so that the cereal flakes maintain structural integrity after processing.

### Flavor Additives

The cereal flakes include flavor additives to improve taste. The flavor additives are typically present in an amount of at least 6.5 wt %, preferably 6.5 to 17.5 wt %, and more preferably 9.5 to 14.5 wt %, based on the total weight of the cereal flakes.

The flavor additives typically include ingredients having a high sugar content, such as syrups, to enhance sweetness of the cereal flakes. In one embodiment, the cereal flakes include brown rice syrup in an amount of at least 2 wt %, preferably 2 to 6 wt %, and more preferably 3 to 5 wt %. The cereal flakes preferably include evaporated cane juice crystals in an amount of at least 4 wt %, and preferably 4 to 10.5 wt %.

The flavor additives can also include salt or spices. In one embodiment, the cereal flakes include salt, such as a hi-grade evaporated salt, in an amount of at least 0.1 wt %, preferably 0.1 to 3 wt %, and more preferably 0.5 to 2 wt %.

### Other Ingredients

The cereal flakes can also include other ingredients typically found in ready-to-eat cereals, such as supplements and preservatives. The other ingredients can be added to improve appearance, texture, or nutrition content of the cereal flakes. A coating can be applied to the finished cereal flakes to enhance the appearance of the ready-to eat cereal flakes, such as an oil-based coating used to coat conventional ready-to-eat cereal flakes. In one embodiment, the coating includes at least one sweetener to enhance sweetness of the cereal flakes. For example, the coating can be a sugar-based coating used to coat conventional ready-to-eat cereal flakes.

### Method of Forming the Cereal Flakes

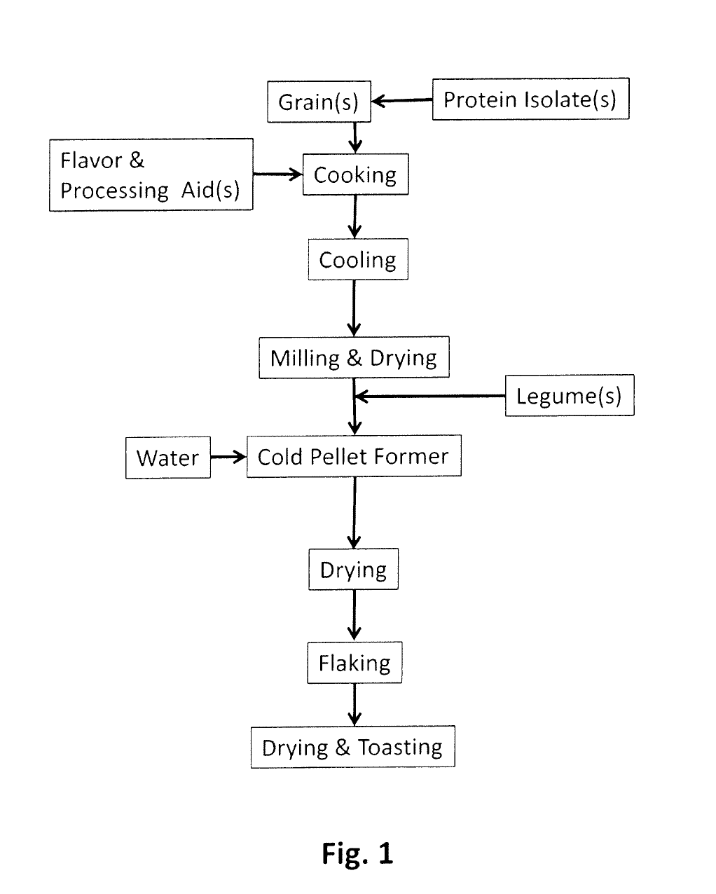

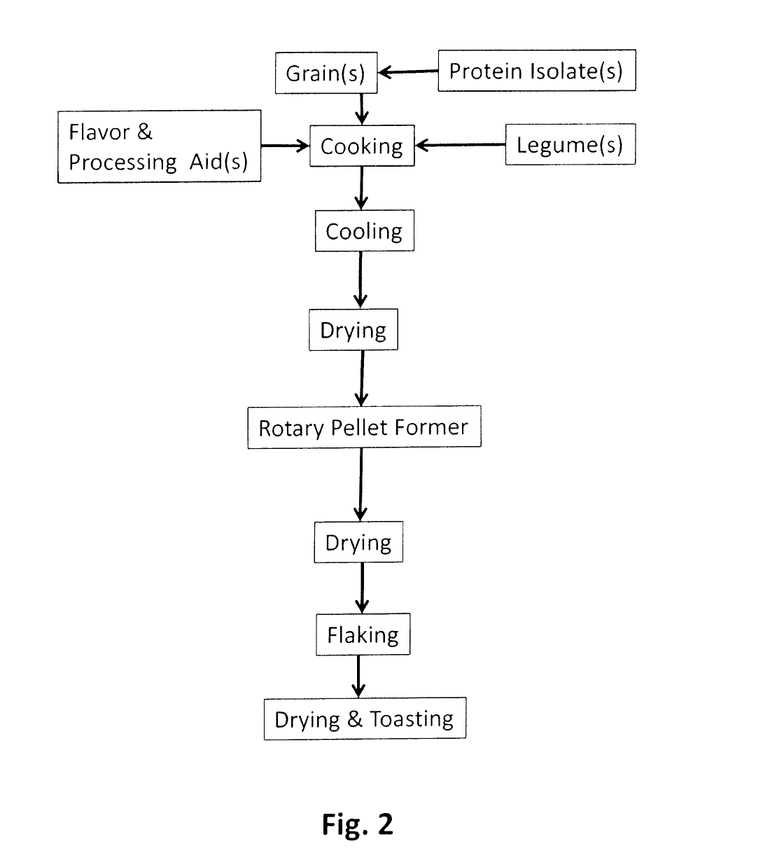

The method of forming the cereal flakes first includes providing pellets including legumes and grains, and then forming the pellets into flakes. A flow diagram of a preferred method of forming the cereal flakes is shown in FIG. 1, wherein the pellets are formed using a cold pellet forming process. An alternative method is shown in FIG. 2, wherein the pellets are formed using a rotary pellet forming process.

As shown in FIG. 1, the preferred method first includes cooking the grains and protein isolate in a pressure cooker, such as a commercial rotary steam pressure cooker. The grains and protein isolate are cooked for 60 minutes at a steam pressure of 20 to 25 pounds per square inch. The cooking temperature will depend on the steam pressure and is determined by steam tables, but is typically 259 to 267° F. Next, the flavor additives, processing aids, and water are added to the pressure cooker and cooked along with the grains and protein isolate. The mixture is cooked at a steam pressure of 20 to 25 pounds per square inch and to a moisture content of 30 to 36 wt %, preferably 32 to 34 wt %, based on the total weight of the cooked mixture. The cooked mixture is then removed from the pressure cooker, cooled, and dried in a conventional fluidized bed type dryer operating at about ambient temperature to a moisture content of 26 to 32 wt %, preferably 28 to 30 wt %.

The method next includes milling the dried mixture through a ⅛ to ⅝ inch mesh screen to break the lumps and create a free flowing cooked mixture. The milled mixture is then dried to a moisture content of 20 to 26 wt %, preferably 22 to 24 wt %. The milled mixture is typically dried in the conventional fluidized bed type dryer, for example operating at a temperature of 220° F. for 10 to 12 minutes.

The milled mixture is next combined with the legumes and additional water and the combined mass is cold formed into a plurality of non-expanded pellets. Cold forming extrusion processes used to form conventional ready-to-eat breakfast cereals can be used to form the pellets. The cold forming process typically includes adding the cooked mixture at a flow rate of 6 to 10 pounds per minute to an extruder, the legumes at a flow rate of 1 to 2 pounds per minute, and water at a flow rate of about 0.5 to 1.5 pounds per minute. The extruder includes screws for blending the ingredients and forcing the combined mass through the orifice of the extruder. The combined mass includes the grains in an amount of at least 18 wt % and the legumes in an amount of 10 to 50 wt %, based on the total weight of the combined mass. The combined mass is maintained at a temperature of less than 100° F. as it moves through the extruder.

The extruder operates at a die pressure of 1,700 to 2,000 pounds per square inch, and the combined mass is cut into a plurality of non-expanded pellets immediately upon exiting the extruder. The extruder includes a blade passing across the orifice, also referred to as a die, of the extruder, typically at a speed of 300 to 320 rpm for cutting the combined mass into a plurality of pellets having a weight of 6 to 9 grams per 25 pellets. The cold-formed pellets have a moisture content of 24 to 30 wt %, preferably 26 to 28 wt %, based on the total weight of the pellets.

Next, the pellets are dried to a moisture content of 14 to 21 wt %, more preferably 17 to 19 wt %. Typically, the pellets are dried in the conventional fluidized bed type dryer maintaining a temperature less than the boiling point of water, which is 212° F., for example the conventional fluidized bed type dryer operating at a temperature of 190° F. for 4 minutes. The dried pellets are then added to a flaking mill, such as a conventional flaking mill used to form conventional ready-to-eat cereal flakes. The pellets are preferably at a temperature of 110 to 150° F., more preferably 130 to 140° F., when added to the flaking mill. The flaking mill is used to press the pellets at a temperature of 110 to 150° F. into the cereal flakes. The flaking mill typically includes rollers operating at a speed of 550 to 650 rpm.

Finally, the cereal flakes are dried and toasted in a conventional hot air impingement type oven to a moisture content of 1 to 5 wt %, preferably 2 to 4 wt %, and a “can weight” of 19 to 22 ounces. The finished ready-to-eat cereal flakes have a structural integrity, texture, size, shape, and overall appearance similar to conventional ready-to-eat cereal flakes. In one embodiment, the method includes applying a coating to the toasted cereal flakes. Coating processes used for conventional ready-to-eat cereals can be used.

Alternatively, the method of forming the cereal flakes can include a rotary pellet forming process, rather than the cold forming process. As shown in FIG. 2, the alternate method includes cooking the legumes, grains, protein isolate, flavor additives, and processing aids together in the pressure cooker. For example, the ingredients can be cooked in the commercial rotary pressure cooker, at a steam pressure of 20 to 25 pounds per square inch, according to the method described above. Next, the method includes cooling and drying the cooked mixture of legumes, grains, protein isolate, flavor additives, and processing aids to a moisture content of 26 to 32 wt %, preferably 28 to 30 wt %. The dry, cooked mixture is added to a rotary pellet former and formed into non-expanded pellets. Rotary pellet forming processes used to form conventional ready-to-eat cereals can be used to form the pellets. The method next includes forming the non-expanded pellets into flakes according to the process described above. The method finally includes drying and toasting the ready-to-eat cereal flakes in a conventional hot air impingement type oven.

A third method includes forming the non-expanded pellets using a direct expansion extruder, referred to as a DX extruder. This method includes providing the dry ingredients, liquid flavoring, and water to the DX extruder. In one embodiment, the dry ingredients are added to the DX extruder at a rate of 2.5 to 4.5 pounds per minute; the water is pumped into the DX extruder at a flow rate of 0.6 to 1.0 pounds per minute; and the liquid flavoring is pumped into the extruder at a flow rate of 0.4 to 0.6 pounds per minute.

The dry ingredients and water are blended and cooked in the barrel of the DX extruder. Unlike the methods of FIGS. 1 and 2, a pressure cooker is not used to cook the mixture. The barrel includes screws for blending the ingredients and forcing the combined mass through zones of the extruder. In one embodiment, the extruder includes three zones. The first zone operates at a temperature of 150° F. to 200° F., the second zone operates at a temperature of 200° F. to 300° F.; and the third zone operates at a temperature of 250° F. to 350° F. The screws of the DX extruder operate at a speed of 250 to 300 rpm. The DX extruder maintains a consistent pressure of 400 to 800 psi throughout.

The screws force the cooked mass through the barrel and through the die of the DX extruder. The cooked mass has temperature of 250 to 300° F. at the die orifice. The DX extruder operates at a die pressure of 400 to 800 psi. The cooked mass is extruded from the DX extruder in the form of a plurality of ropes and without expansion of the cooked mass.

The ropes are transferred from the die of the DX extruder to a cold pellet former via a plurality of tubes. The ropes enter the cold former at a temperature of 180° F. to 220° F. The cold pellet former operates at a temperature of 100° F. to 150° F. and a pressure of 0 psi. The cold pellet former includes screws operating at a speed of 10 to 15 rpm forcing the ropes through former. The former has a die temperature of 150° F. to 175° F. The cooked ropes exit a die of the cold pellet former without expansion. The former includes a blade passing across the die, cutting the cooked ropes into a plurality of non-expanded pellets. In one embodiment, the blade operates at a speed of 70 to 110 rpm, and the rope is cut into a plurality of pellets having a weight of 30 to 40 grams per 100 pellets. The non-expanded, cold formed pellets have a moisture content 31 to 33 wt %, based on the total weight of the pellets.

Next, the pellets are dried to a moisture content of 20 to 24 wt % and then added to a flaking mill, such as a conventional flaking mill used to form conventional ready-to-eat cereal flakes. The pellets are preferably at a temperature of 110° F. to 130° F. when added to the flaking mill. The flaking mill is used to press the pellets at a temperature of 110° F. to 130° F. into the cereal flakes. The flaking mill typically includes rollers operating at a speed of 550 to 650 rpm.

Finally, the cereal flakes are dried and toasted in a conventional hot air impingement type oven to a moisture content of 1 to 5 wt % and a “can weight” of 19 to 22 ounces. The finished ready-to-eat cereal flakes have a structural integrity, texture, size, shape, and overall appearance similar to conventional ready-to-eat cereal flakes. The finished cereal flakes typically include the legumes in an amount of 10 to 50 wt %, the protein isolate in an amount of 6 to 13 wt %, processing aid in an amount of 3 to 9 wt %, and the grains in an amount of 18 to 66 wt %, based on the total weight of the finished cereal flakes. In one embodiment, the method includes applying a coating to the toasted cereal flakes. Coating processes used for conventional ready-to-eat cereals can be used.

### Example 1

An example composition for a 250 pound batch of the ready-to-eat cereal flakes is disclosed in Table 1. The amount of each ingredient is provided in wt % based on the total weight.

TABLE 1

| Ingredients | Wt % |
|---|---|
| Precooked Dehydrated Black Beans | 16.01 |
| Whole Grain Blend | 3.31 |
| Broken Whole/Medium Grain Brown Rice | 16.36 |
| Evaporated Cane Juice Crystals | 5.76 |
| Brown Rice Syrup 42DE | 2.71 |
| Hi-Grade Evaporated Salt | 0.72 |
| Cracked Hard Red Winter Wheat | 22.90 |
| Gum Acacia | 4.92 |
| Pea Protein Isolate | 7.20 |
| Water | 20.11 |

The example process first includes dry blending the whole grain blend, brown rice, red wheat, and pea protein isolate together and then cooking the dry blend in a commercial rotary steam pressure cooker. The dry blend is cooked for 60 minutes at a steam pressure of 20 pounds per square inch. Next, the evaporated cane juice crystals, gum acacia, and brown rice syrup are added to the pressure cooker, and cooked along with the grains and protein isolate. The mixture is cooked at a pressure of 20 pounds per square inch and to a moisture content of 32 to 34 wt %, based on the total weight of the cooked mixture. The cooked mixture is then removed from the pressure cooker and cooled. The cooked mixture is dried to a moisture content of 28 to 30 wt % in a conventional fluidized bed type dryer. The cooked mixture is dried in the conventional fluidized bed type dryer operating at ambient temperature for 4 minutes.

The method next includes milling the dried mixture through a ⅜ inch mesh screen. The milled mixture is dried in the conventional fluidized bed type dryer operating at a temperature of 22° F. and 432 rpm for 10 to 12 minutes and to a moisture content of 22 to 24 wt %.

The milled mixture is then combined with the precooked, dehydrated black beans, salt and additional water, and placed in a cold pellet forming extruder. The precooked, dehydrated black beans are provided in the form of particulates. The cold forming process includes adding the milled mixture at a flow rate of 8 pounds per minute to the extruder, the black bean particulates at a flow rate of 1.54 pounds per minute, and the additional water at a flow rate of 0.9 pounds per minute. The extruder includes a transfer screw rotating at 9 to 10 rpm and a transfer torque of 7 to 8%, and a main screw rotating at 18 to 19 rpm and a main torque of 50 to 54%. The screws blend the milled mixture and black beans into a combined mass and force the combined mass straight through the orifice of the extruder. The combined mass is maintained at a temperature of 90 to 95° C., as it moves through the extruder.

The extruder operates at a die pressure of 1,700 to 2,000 pounds per square inch, and the combined mass is cut into a plurality of non-expanded pellets immediately upon exiting the extruder. The extruder includes a blade passing across the die orifice of the extruder at a speed of 308 rpm for cutting the combined mass into a plurality of the pellets having a weight of 7 to 8 grams per 25 pellets. The cold-formed pellets have a moisture content of 26 to 28 wt %, based on the total weight of the pellets.

Next, the cold-formed pellets are dried in the conventional fluidized bed type dryer operating a temperature of 190° F. for 4 minutes. The cold-formed pellets are dried to a moisture content of 17 to 19 wt %. The finished pellets are maintained at a temperature above 190° F. and subsequently used for flaking.

The finished pellets are added to a flaking mill, such as a conventional flaking mill used to form conventional ready-to-eat cereal flakes. The pellets are at a temperature of 136° F. and a moisture content of 17 to 19 wt % when added to the flaking mill. The pellets are pressed into the cereal flakes while the pellets are at a temperature of 136° F. The pellets are pressed by rollers rotating at a speed of 600 rpm with no speed differential.

The cereal flakes are dried in a conventional hot air impingement type oven. The cereal flakes are toasted to a moisture content of 3 wt %. The finished ready-to-eat cereal flakes formed according to Example 1 have a can weight of 19 to 22 ounces, a moisture content of 3 wt %, and a structural integrity, texture, size, shape, and overall appearance similar to conventional ready-to-eat cereal flakes. The ready-to-eat cereal flakes of the invention also have a bowl life similar to conventional ready-to-eat cereal flakes. The ready-to-eat cereal flakes maintain a desirable crunchiness for over two minutes when disposed in a bowl of milk.

The ready-to-eat cereal flakes can be packaged and sold as a food product, such as a ready-to-eat breakfast cereal. Alternatively, the cereal flakes can be combined with other ready-to-eat cereals or components, such as nuts, fruits, or syrups to provide a food product. The cereal flakes can also be incorporated into other food products.

### Example 2

An example composition for a 79 pound batch of the ready-to-eat cereal flakes is disclosed in Table 2. The amount of ingredient is provided in wt % as described above.

TABLE 2

| Ingredients | Wt % |
|---|---|
| Precooked Dehydrated Black Bean Grits | 15.06 |
| Whole Grain Blend | 4.22 |
| Brown Rice Flour | 15.69 |
| Evaporated Cane Juice Crystals | 5.49 |
| Wheat Flour | 22.24 |
| Hi-Grade Evaporated Salt | 0.70 |
| Wheat Bran | 7.04 |
| Gum Acacia | 8.44 |
| Pea Protein Isolate | 7.04 |
| Water | 14.08 |

The example process first includes adding the ingredients to a DX extruder. The dry ingredients, including the black bean grits, whole grain blend, brown rice flour, wheat flour, salt, wheat bran, gum acacia, and pea protein isolate are added to the DX extruder at a rate of 3.5 pounds per minute. As the dry ingredients are added, water and flavoring is simultaneously pumped into the DX extruder. The water is pumped into the DX extruder at a flow rate of 0.8 pounds per minute and the flavoring, including a mixture of water and cane juice crystals, is pumped into the DX extruder at a flow rate of 0.5 pounds per minute.

The dry ingredients and water are blended and cooked in the barrel of the DX extruder. A pressure cooker is not used to cook the mixture. The barrel includes two screws for blending the ingredients and forcing the combined mass through zones of the DX extruder. The screws of the DX extruder operate at a speed of 275 rpm. The extruder includes three zones. The first zone operates at a temperature of 180° F., the second zone operates at a temperature of 250° F., and the third zone operates at a temperature of 300° F. The DX extruder maintains a consistent pressure of 450 psi throughout.

The screws force the cooked mass through the barrel and through the die of the DX extruder. The cooked mass has temperature of 296° F. at the die orifice. The DX extruder operates at a die pressure of 450 psi. The cooked mass is extruded from the DX extruder in the form of a plurality of ropes and without expansion of the cooked mass.

The ropes are transferred from the die of the DX extruder to a cold pellet former by a plurality of tubes. The ropes enter the cold former at a temperature of 204° F. The cold pellet former operates at a temperature of 125° F. and a pressure of 0 psi. The cold pellet former includes screws operating at a speed of 13 rpm forcing the ropes through the former to a die. The former has a die temperature of 161° F. The cooked ropes exit the die orifice of the cold pellet former without expansion. The former includes a blade passing across the die of former for cutting the cooked ropes into a plurality of non-expanded pellets. The blade operates at a speed of 90 rpm, and the rope is cut into a plurality of pellets having a weight of 36.1 grams per 100 pellets. The non-expanded, cold formed pellets have a moisture content of 32.1 wt %, based on the total weight of the pellets.

Next, the pellets are dried to a moisture content of 22 wt % and then added to a conventional flaking mill used to form conventional ready-to-eat cereal flakes. The pellets are at a temperature of 125° F. when added to the flaking mill. The flaking mill is used to press the pellets at a temperature of 125° F. into the cereal flakes. The flaking mill typically includes rollers operating at a speed of 600 rpm with no speed differential.

Finally, the cereal flakes are dried and toasted in a conventional hot air impingement type oven to a moisture content of 3 wt % and a “can weight” of 19 to 22 ounces. The finished ready-to-eat cereal flakes formed according to Example 2 have a structural integrity, texture, size, shape, and overall appearance similar to conventional ready-to-eat cereal flakes. A coating of 99.9 wt % evaporated cane juice syrup and 0.1 wt % flavored spices is applied to the finished cereal flakes, according to a process used to coat conventional ready-to-eat cereal flakes. The ready-to-eat cereal flakes also have a bowl life similar to conventional ready-to-eat cereal flakes. The ready-to-eat cereal flakes also maintain a desirable crunchiness for over two minutes when disposed in a bowl of milk. The ready-to-eat cereal flakes are blended with another ready-to-eat cereal, specifically a cluster of almonds and beans, to provide a ready-to-eat cereal product. The flakes prepared according to the present invention may include any sort of a coating as usually applied to a flaked ready to eat cereal, for example sweetener-based coatings as described above. The sweetener-based coatings can include, for example, sucrose, glucose, fructose, corn syrup, corn syrup solids, rice syrup, evaporated cane juice crystals, evaporated cane juice syrup, invert sugar, honey, molasses, and any other nutritive sweeteners used in coating cereals.

The foregoing invention has been described in accordance with the relevant legal standards, thus the description is exemplary rather than limiting in nature. Variations and modifications to the disclosed embodiments may become apparent to those skilled in the art and do come within the scope of the invention. Accordingly, the scope of legal protection afforded this invention can only be determined by studying the following claims.

We claim:

1. A flaked ready-to-eat cereal product comprising:
a plurality of flakes comprising grain present in an amount of 18 to 66 weight percent, legumes present in an amount of 10 to 50 weight percent, protein isolate present in an amount of 6 to 13 weight percent, and processing aid present in an amount of 3 to 9 weight percent, all based on the total weight of said flakes.

2. The cereal product recited in claim 1 including at least one protein isolate selected from the group consisting of pea protein isolate, soy protein isolate, gluten protein isolate, milk protein isolate, and mixtures thereof.

3. The cereal product recited in claim 2 wherein said protein isolate comprises pea protein isolate present in an amount of from 6 to 13 weight percent.

4. The cereal product recited in claim 1 comprising from 35 to 66 weight percent of said one or more grains.

5. The cereal product as recited in claim 1 comprising 2 to 8 weight percent of whole grains.

6. The cereal product as recited in claim 1 comprising 15 to 22 weight percent legume.

7. The cereal product as recited in claim 1 wherein the processing aid comprises gum acacia in an amount of from 3 to 9 weight percent.

8. The cereal product as recited in claim 1 comprising on a 52 gram basis 7 to 9 grams of protein and 6 to 8 grams of fiber.

9. The cereal product as recited in claim 1 comprising from 10 to 25 weight percent of rice.

10. The cereal product as recited in claim 1 comprising from 22 to 34 weight percent of wheat.

11. The cereal product as recited in claim 1 comprising a sweetener-based coating.

12. A method of forming a flaked ready-to-eat cereal comprising the steps of:
a.) forming a food mass by combining in an extruder grain in an amount of from 18 to 66 weight percent, legumes in an amount of 10 to 50 weight percent, protein isolate in an amount of 6 to 13 weight percent, and processing aid in an amount of 3 to 9 weight percent, all based on the total weight of said food mass, and cooking said food mass in said extruder;
b.) extruding said cooked food mass from said extruder in a non-expanded form and introducing said non-expanded extrudate into a cold-former pellet former and forming said food mass into non-expanded pellets at a temperature of 100° F. or less, said non-expanded pellets having a moisture content of from 24 to 33 weight percent and a density of from 30 to 40 grams per 100 pellets;
c.) drying said pellets to a moisture content of from 14 to 24 weight percent;
d.) flaking said pellets at a temperature of from 110 to 150° F.; and
e.) drying and toasting said flakes to a final moisture content of from 1 to 5 weight percent.

13. The method of claim 12 wherein step a.) further comprises cooking the food mass in said extruder by passing the food mass sequentially through at least three zones with a first zone having a temperature of from 150 to 200° F., a second zone having a temperature of from 200 to 300° F., and a third zone having a temperature of from 250 to 350° F. and with said extruder operating under a pressure of from 400 to 800 pounds per square inch.

14. The method of claim 12, wherein step a.) further comprises using a protein isolate selected from the group consisting of pea protein isolate, soy protein isolate, gluten protein isolate, milk protein isolate, and mixtures thereof.

15. The method of claim 12 wherein step a.) further comprises forming said food mass using from 2 to 8 weight percent whole grain.

16. The method of claim 12 wherein step a.) further comprising using as said processing aid gum acacia present in an amount of from 3 to 9 weight percent.

17. A method of forming a flaked ready-to-eat cereal comprising the steps of:
a.) forming a food mass by combining in a cooker grain and protein isolate and cooking said food mass in said cooker at a pressure of 20 to 25 pounds per square inch;
b.) adding to the food mass from step a.) water and processing aid and cooking at 20 to 25 psi until a moisture content of the food mass is from 30 to 36 weight percent;
c.) removing the cooked food mass from cooker and then cooling the cooked food mass and drying it to a moisture content of from 24 to 33 weight percent;
d.) milling the cooked food mass through a screen having openings of from ⅛ to ⅝ of an inch in diameter and then further drying the milled food mass to a moisture content of from 20 to 26 weight percent;
e.) combining the milled food mass with legumes and further water in a cold pellet former and cold forming non-expanded pellets;
f.) drying the pellets to a moisture content of from 14 to 21 weight percent and then flaking them at a temperature of from 110 to 150° F.; and
g.) drying and toasting the flakes to a final moisture content of from 1 to 5 weight percent.

18. The method as recited in claim 17 wherein step a.) comprises providing the grain in an amount of from 18 to 66 weight percent and the protein isolate in an amount of 6 to 13 weight percent based on the total weight of the flakes.

19. The method as recited in claim 17 wherein step b.) comprises providing as said processing aid gum acacia present in an amount of from 3 to 9 weight percent based on the total weight of the flakes.

20. The method as recited in claim 17 wherein step e.) comprises providing the legumes in an amount of from 10 to 50 weight percent based on the total weight of the flakes.

21. A method of forming a flaked ready-to-eat cereal comprising the following steps:
a.) cooking grain in an amount of from 18 to 66 weight percent, protein isolate in an amount of 6 to 13 weight percent, legumes in an amount of from 10 to 50 weight percent and processing aid in an amount of from 3 to 9 weight percent based on the total weight of the flakes at 20 to 25 psi to a moisture content of from 30 to 36 weight percent;
b.) remove the cooked mass from the cooker and cool and dry to a moisture content of from 26 to 32 weight percent;
c.) adding the dried food mass to a rotary pellet former and cold forming non-expanded pellets;
d.) drying the pellets to a moisture content of from 14 to 21 weight percent and then flaking them at a temperature of from 110 to 150° F.; and
e.) drying and toasting the flakes to a final moisture content of from 1 to 5 weight percent.
